(19) United States
(12) Patent Application Publication
(10) Pub. No.: US 2023/0052451 A1
(43) Pub. Date: Feb. 16, 2023

(54) SPRAY DRIED, LOW-SODIUM, SALT COMPOSITION FOR SALT REDUCTION

(71) Applicant: International Flavors & Fragrances, Inc., New York, NY (US)

(72) Inventors: Willy W. Lee, Piscataway, NJ (US); Ronald Gabbard, Union Beach, NJ (US); Krishna Raghupathi, Union Beach, NJ (US); Adam Toth, Union Beach, NJ (US)

(21) Appl. No.: 17/790,265

(22) PCT Filed: Jan. 7, 2021
(86) PCT No.: PCT/US21/12399

§ 371 Date: Jun. 30, 2022

Related U.S. Application Data
(60) Provisional application No. 62/958,929, filed on Jan. 9, 2020.

(51) Int. Cl. A23L 27/40; A23L 3/46

(52) U.S. Cl. CPC A23L 27/40; A23L 3/46; A23V 2002/00

(57) ABSTRACT

A spray dried, low-sodium, salt composition comprising a plurality of microspheres is provided, wherein said microspheres are composed of sodium chloride; a salt modulator; and a matrix polymer, and wherein said microspheres have an average particle size of less than 30 microns and have the sodium chloride distributed on the surface thereof.

This application claims the benefit of priority of U.S. Provisional Application No. 62/958,929 filed Jan. 9, 2020, the contents of which are incorporated herein by reference in their entirety.

### BACKGROUND

High salt (sodium) consumption is increasingly recognized as a negative factor for poor health, contributing to serious illness such as high blood pressure, heart disease, and stroke. Therefore, there is a need for improved salt replacement compositions having desirable taste characteristics, and suitable ingredient properties for food applications.

U.S. Pat. Nos. 8,197,878 and 8,802,181 describe a low sodium salt composition including sodium chloride and a modified chloride salt composition composed of a homogenous amalgamation of chloride salt (15% to about 30%), food grade acidulant (0.1% to about 3%), and carrier, which does not contain sodium chloride.

U.S. Pat. Nos. 8,435,555 and 9,491,961 describe a salt product composed of particles containing: salt and an organic material such as a carbohydrate, protein and synthetic organic polymer, wherein said particles are produced by atomization and evaporation using, e.g., a conventional spray drying apparatus.

U.S. Pat. No. 8,900,650 discloses a low-sodium salt composition including a carrier particle having disposed thereon a plurality of salt crystallites of an average size of less than about 20 microns.

US 2009/0104330 and US 2017/0135390 describe a composition for reduction of sodium chloride in food, which is composed of sodium chloride, at least one food acid selected from citric acid, lactic acid, malic acid and salts thereof, and at least one amino acid selected from the group consisting of lysine, arginine, aspartic acid, histidine, or a salt thereof.

WO 2007/045566 describes a mixture having a salty taste and comprising or consisting of: (a) 1 to 50 weight percent of one or more inorganic salts which are suitable for nutrition and are not sodium chloride, (b) 10 to 90 weight percent of one or more mono- or polyvalent salts of polybasic food acids, (c) 0.1 to 30 weight percent of one or more amino acids, or salts thereof, which are suitable for nutrition, (d) 0 to 20% weight percent of sodium chloride.

### SUMMARY OF THE INVENTION

This invention provides a spray dried, low-sodium, salt composition composed of a plurality of microspheres, wherein said microspheres include (a) 35 to 65 weight percent sodium chloride; (b) 5 to 40 weight percent salt modulator comprising at least one amino acid, at least one food acid, and at least one carbonate salt; and (c) 5 to 25 weight percent matrix polymer, and wherein said microspheres have an average particle size of less than 30 microns and have the sodium chloride distributed on the surface thereof. In certain embodiments, the sodium chloride is 50 to 60 weight percent of the microspheres, the salt modulator is 10 to 30 weight percent of the microspheres, and/or the matrix polymer is 15 to 20 weight percent of the microspheres. In other embodiments, the salt modulator is composed of arginine, succinic acid, fumaric acid, acetic acid, potassium carbonate and magnesium carbonate. In further embodiments, the matrix polymer is one or more of agar, alginate, carrageenan, furcellaran, fucoidin, laminarin, guar gum, tara gum, tamarind seed gum, gum Arabic, alternan, gum tragacanth, gum ghatti, karaya gum, locust bean gum, galactomannan, pusstulan, laminarin, scleroglucan, inulin, konjac seed flour or konjac mannan, pectin, gelatin, psyllium, okra gums, tamarind, dextran, polydextran, gellan gum, rhamsan gum, whelan gum, xanthan gum, zooglan, methylan, chitosan, scleroglucan, dextrin, cyclodextrin, maltodextrin, methyl cellulose, carboxymethylcellulose, hydroxypropylcellulose, hydroxyethyl cellulose, hydroxypropyl methylcellulose, propylene glycol alginate, hydroxyalkylated guar, starch, carboxymethylated guar or modified starches.

A method of producing the spray dried, low-sodium, salt composition is also provided, which involves spray drying an aqueous solution composed of sodium chloride, a salt modulator and a matrix polymer to produce a spray dried, low-sodium, salt composition containing a plurality of microspheres having an average particle size of less than 30 microns and having the sodium chloride distributed on the surface thereof. In certain aspects of this method the spray drying process includes an inlet temperature of between about 180° C. and about 200° C., an outlet temperature of about 80° C. and about 100° C., an air flow between about 180 cubic feet per minute (cfm) to 220 cfm, a feed rate between about 130 g/min and about 160 g/min, and a spray pressure of between about 3 bar and about 5 bar. In some embodiments, the sodium chloride is 15 to 35 weight percent of the aqueous solution; the salt modulator is 5 to 20 weight percent of the aqueous solution; and the matrix polymer is 2 to 15 weight percent of the aqueous solution. In other embodiments, the salt modulator comprises arginine, succinic acid, fumaric acid, acetic acid, potassium carbonate and magnesium carbonate. In further embodiments, the matrix polymer is one or more of agar, alginate, carrageenan, furcellaran, fucoidin, laminarin, guar gum, tara gum, tamarind seed gum, gum Arabic, alternan, gum tragacanth, gum ghatti, karaya gum, locust bean gum, galactomannan, pusstulan, laminarin, scleroglucan, inulin, konjac seed flour or konjac mannan, pectin, gelatin, psyllium, okra gums, tamarind, dextran, polydextran, gellan gum, rhamsan gum, whelan gum, xanthan gum, zooglan, methylan, chitosan, scleroglucan, dextrin, cyclodextrin, maltodextrin, methyl cellulose, carboxymethylcellulose, hydroxypropylcellulose, hydroxyethyl cellulose, hydroxypropyl methylcellulose, propylene glycol alginate, hydroxyalkylated guar, starch, carboxymethylated guar or modified starches. A spray dried, low-sodium, salt composition produced by this method is also provided as is a food containing the same.

### BRIEF DESCRIPTION OF THE DRAWINGS

FIG. 1 shows the salt intensity of potato chips including a topical application of 100% salt or 75% salt in combination with a salt modulator.

FIG. 2 shows is a high-resolution scanning electron microscope (SEM) image of co-spray dried particle with salt (NaCl) crystallization observed on particle surface.

### DETAILED DESCRIPTION OF THE INVENTION

For table-top or surface (sprinkle-on) applications, most commercially available salt is not immediately soluble in saliva because of its high density and relatively large particle size. When these particles are sprinkled on foods for immediate consumption or during further processing, they provide low intensity, long lasting, spotty salty taste. Most prepared foods are only briefly chewed and swallowed; thus, salt is sometimes added in a relatively high concentration to compensate for incomplete dissolution and the short mouth residence time. For example, one serving (28 g) of Lay's Classic contains 170 mg of sodium, or 432 mg of salt (NaCl), which is 7% of the recommended daily consumption. However, it has been shown that only about 20% of the salt on potato chips actually dissolves in the mouth, while about 80% is swallowed without enhancing the taste benefit (Adams (April 2010) Popular Sci.). As a result, a consumer may ingest salt that is still in granule form and thereby consume far greater quantities of sodium than necessary to achieve a desired “salty” taste.

In general, a desired level of salty flavor can be achieved, while reducing sodium consumption, by providing small consumable salt particles having a large surface area-to-volume ratio. In general, the surface area-to-volume ratio of a particle increases as the size of the particle decreases. Thus, in one aspect, small salt particles provide increased interaction with saliva and sensory physiology in the mouth, e.g., tongue, cheeks, gums, etc., which can lead to an increased sensation of a salty taste. Because more of the salt particle surface is exposed to saliva, the dissolution rate of salt particles is greater as compared to regular, commercial-grade salt particles that one may find, e.g., at a restaurant. Because the residence time of food is relatively short in the mouth, increasing the dissolution rate of salt particles can have a pronounced effect on the sensation of salty taste.

A process and formulation for making microspheres has now been developed that can reduce the use level of salt (NaCl), while maintaining similar salty perception. The microspheres are made by dissolving regular rock salt (NaCl), a salt modulator, and a water-soluble polymer in water, and then subsequently spray drying the solution. The microspheres are not only very fine (<30 microns in diameter), but also the sodium chloride blooms to the particle surface. Fast dissolution of the sodium chloride due to increased surface area, along with the synergistic effects with the modulator, provides for retention of sensory attributes at lower use levels of sodium chloride. In addition, the lower levels of water-soluble polymer used in the instant formulation combined with smaller particle sizes achieved via the process herein results in higher surface exposure of salt and modulator during use.

Accordingly, this invention is a spray dried, low-sodium, salt composition composed of a plurality of microspheres, which can significantly reduce the amount of sodium chloride in food, seasonings or flavorings and provide a good salty taste to food. The microspheres of the spray dried, low-sodium, salt composition comprise, consist of, or consist essentially of sodium chloride, a salt modulator, and a matrix polymer and can be consumed as an alternative to pure sodium chloride (“table salt”). For the purposes of this invention, “low-sodium, salt composition” refers to a composition with a reduced level of sodium compared to conventional table salt, wherein the composition provides a salty taste that is substantial equivalent to table salt.

A “microsphere” refers to a micron-sized spherical particle. “Microspheres” can refer to a specific size, e.g., a narrow size distribution of particles, or a collection of particles of different sizes, e.g., a mean size for a population of microspheres. Preferably, the microspheres described herein have a mean particle diameter of less than or equal to 30 microns, e.g., between about 100 nm and about 30 microns, or between 1 micron and 30 micron. Mean particle diameters are preferably about 100 nm, 200 nm, 300 nm, 400 nm, 500 nm, 600 nm, 700 nm, 800 nm, 900 nm, 1 micron, 2.0 microns, 3.0 microns, 4.0 microns, 5.0 microns, 10 microns, 15 microns, 20 microns, or 25 microns.

Median values are defined as the value where half of a population of particles resides above the point, and half resides below the point. For particle size distributions the median is called the D50. Similarly, 90 percent of the distribution lies below the D90, and 10 percent of the population lies below the D10. In accordance with the present invention, the D90 of the microspheres is desirably in the range of 20 microns to 60 microns or more preferably 30 microns to 50 microns; the D50 is in the range of 1 micron to 40 microns or more preferably 10 microns to 30 microns; and/or the D10 is in the range of 100 nm to 30 microns or more preferably in the range of about 1 micron to 20 microns. In certain embodiments, the D90 is in the range of about 40 microns to 45 microns; the D50 is in the range of about 15 microns to 25 microns; and the D10 is in the range of about 5 microns to 15 microns.

The mode is the peak of the frequency distribution, or the highest peak seen in the distribution. The mode represents the particle size (or size range) most commonly found in the distribution. In accordance with the present invention, the mode of the microspheres is in the range of 1 micron to 40 microns or more preferably 10 microns to 30 microns. In certain embodiments, the mode of the microspheres is in the range of 15 microns to 25 microns.

Sodium chloride is one of the components of the microspheres of the spray dried, low-sodium, salt composition. It is added to achieve synergistic salty taste enhancement in the presence of other components and mask possible off-notes of other components. Sodium chloride can be in any liquid or solid crystalline form originating from mineral or rock salt, or other significant sources of sodium chloride. Regular rock salt is in cubical crystal form. However, sodium chloride can be provided in various crystalline or partially amorphous shapes known in the industry: from large coarse random crystals to granulated, flaked, or micronized salt.

The sodium chloride component is used in an amount in the range of 35 weight percent to 65 weight percent of the dry weight of the microspheres of the spray dried, low-sodium, salt composition, or a range delimited by these weight percentages. More preferably, the sodium chloride is 50 to 60 weight percent of the dry weight of the microspheres. Prior to spray-drying, an aqueous solution composed of sodium chloride, a salt modulator and a matrix polymer can include the sodium chloride in the range of 15 weight percent to 35 weight percent of the aqueous solution, more preferably, 20 weight percent to 30 weight percent of the aqueous solution, or a range delimited by these weight percentages.

A salt modulator is another component of the microspheres of the spray dried, low-sodium, salt composition. As used herein, a “salt modulator” refers to a composition that enhances or potentiates the salty taste, perception of saltiness, saltiness intensity or perception of saltiness intensity of an edible composition comprising a salt. A salt modulator of this invention comprises, consists of, or consist essentially of at least one amino acid, at least one food acid, and at least one carbonate salt. In certain embodiments, the salt modulator is composed of at least one amino acid, at least two or three food acids, and at least two or three carbonate salts.

Suitable amino acid additives for use in the salt modulator of this disclosure include, but are not limited to, aspartic acid, arginine, glycine, glutamic acid, proline, threonine, theanine, cysteine, cystine, alanine, valine, tyrosine, leucine, isoleucine, asparagine, serine, lysine, histidine, ornithine, methionine, carnitine, aminobutyric acid (α-, β-, or γ-isomers), glutamine, hydroxyproline, taurine, norvaline, sarcosine, and combinations thereof, as well as their salt forms such as sodium or potassium salts or acid salts. The amino acid additive also may be in the D- or L-configuration and in the mono-, di-, or tri-form of the same or different amino acids. Additionally, the amino acids may be α-, β-, γ-, δ-, and ε-isomers if appropriate. Combinations of the foregoing amino acids and their corresponding salts (e.g., sodium, potassium, calcium, magnesium salts or other alkali or alkaline earth metal salts thereof, or acid salts) also are suitable for use in the salt modulator. The amino acids may be natural or synthetic. The amino acids also may be modified. Modified amino acids refer to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. In some embodiments, the amino acid additive of the salt modulator includes at least arginine.

In certain embodiments, the amino acid additive of the salt modulator is arginine HCl. The amino acid additive may be present in an amount of, based upon the dry weight of the spray dried salt composition, about 1% to 10%, or more preferably about 2% to 7%, or most preferably about 4% to 6%.

The organic acid of the salt modulator is one selected from as acetic acid, propionic acid, hexanoic acid, cyclopentanepropionic acid, glycolic acid, pyruvic acid, lactic acid, malonic acid, succinic acid, malic acid, maleic acid, fumaric acid, tartaric acid, citric acid, benzoic acid, 3-(4-hydroxybenzoyl) benzoic acid, cinnamic acid, mandelic acid, methanessulfonic acid, ethanesulfonic acid, 1,2-ethane-disulfonic acid, 2-hydroxyethanesulfonic acid, benzensulfonic acid, 4-chlorobenzenesulfonic acid, 2-naphthalenesulfoic acid, 4-tokuenesulfonic acid, comphorsulfonic acid, 4-methylbicyclo[2.2.2]-octo-2-ene-1-carbolyclic acid, glucoheptonic acid, 3-phylpropionic acid, trimethylacetic acid, tertiary butylacetic acid, lauryl sulfuric acid, gluconic acid, glutamic acid, hydroxynaphtghoic acid, salicylic acid, stearic acid, muconic acid, and combinations thereof. In some embodiments, the organic acid is acetic acid, fumaric acid, succinic acid, or a combination of.

When used in combination, each organic acid may be used in an amount in the range of 0.1% to 10%, or preferably 0.5% to 8%, based upon the dry weight of the spray dried salt composition. By way of illustration, an organic acid composed of a combination of acetic acid, fumaric acid, and succinic acid may include about 1% to 3% acetic acid, about 0.4% to 1.3% fumaric acid and about 5% to about 10% succinic acid, based upon the dry weight of the spray dried salt composition.

The organic acid component (i.e., total of all organic acids included in the salt modulator) is used in an amount in the range of 3 weight percent to 99 weight percent of the dry weight of the salt modulator, or a range delimited by these weight percentages. More preferably, the organic acid component is at least 3 weight percent, at least 3.5 weight percent, at least 4 weight percent, or at least 4.5 weight percent of the dry weight of the salt modulator. In certain embodiments, the organic acid component is used in an amount in the range of 1% to 20%, or preferably 5% to 15%, based upon the dry weight of the spray dried salt composition.

The carbonate salt of the salt modulator is one selected from potassium carbonate (potash), potassium hydrogen carbonate (KHCO₃), magnesium carbonate, magnesium hydrogen carbonate, calcium carbonate, calcium hydrogen carbonate, aluminium carbonate, aluminium hydrogen carbonate, ammonium carbonate, ammonium hydrogen carbonate, ammonium carbamate, hartshorn salt, and combinations thereof. In some embodiments, the carbonate salt is sodium carbonate, potassium carbonate, magnesium carbonate, or a combination of.

When used in combination, each carbonate salt may be used in an amount in the range of 0.1% to 7%, or preferably 0.5% to 4%, based upon the dry weight of the spray dried salt composition. By way of illustration, a carbonate salt composed of a combination of sodium carbonate, potassium carbonate, magnesium carbonate may include about 1% to 4% sodium carbonate, about 1% to 4% potassium carbonate and about 0.4% to 1% magnesium carbonate, based upon the dry weight of the spray dried salt composition.

The carbonate salt component (i.e., total of all carbonate salt included in the salt modulator) is used in an amount in the range of 1% to 12%, or preferably 3% to 8%, based upon the dry weight of the spray dried salt composition.

In some embodiments, the salt modulator comprises arginine, succinic acid, fumaric acid, acetic acid, potassium carbonate, sodium carbonate and magnesium carbonate. In other embodiments, the salt modulator consists essentially of arginine, succinic acid, fumaric acid, acetic acid, potassium carbonate, sodium carbonate and magnesium carbonate. In particular embodiments, the salt modulator consists of arginine, succinic acid, fumaric acid, acetic acid, potassium carbonate, sodium carbonate and magnesium carbonate.

The salt modulator component of the microspheres is used in an amount in the range of 5 weight percent to 40 weight percent of the dry weight of the microspheres of the spray dried, low-sodium, salt composition, or a range delimited by these weight percentages. More preferably, the salt modulator is 10 to 30 weight percent of the dry weight of the microspheres. Prior to spray-drying, an aqueous solution composed of sodium chloride, a salt modulator and a matrix polymer can include the salt modulator in the range of 5 weight percent to 20 weight percent of the aqueous solution, more preferably 10 weight percent to 15 weight percent of the aqueous solution, or a range delimited by these weight percentages.

A matrix polymer of the microspheres of the spray dried, low-sodium, salt composition refers to a food grade, water soluble polymer selected from agar, alginate, carrageenan, furcellaran, fucoidin, laminarin, guar gum, tara gum, tamarind seed gum, gum Arabic (acacia gum), alternan, gum tragacanth, gum ghatti, karaya gum, locust bean gum, galactomannan, pusstulan, laminarin, scleroglucan, inulin, konjac seed flour or konjac mannan, pectin, gelatin, psyllium, okra gums, tamarind, dextran, polydextran, gellan gum, rhamsan gum, whelan gum, xanthan gum, zooglan, methylan, chitosan, scleroglucan, dextrin, cyclodextrin, maltodextrin, methyl cellulose, carboxymethylcellulose, hydroxyalkyl derivatives of cellulose, hydroxypropylcellulose, hydroxyethyl cellulose, hydroxypropyl methylcellulose, propylene glycol alginate, hydroxyalkylated guar, starch, carboxymethylated guar and modified starches, such as resistant starch and cross-linked starch, or combinations thereof. In certain embodiments the matrix polymer of the microspheres is gum Arabic.

The matrix polymer component of the microspheres is used in an amount in the range of 5 weight percent to 25 weight percent of the dry weight of the microspheres of the spray dried, low-sodium, salt composition, or a range delimited by these weight percentages. More preferably, the salt modulator is 15 to 20 weight percent of the dry weight of the microspheres. Prior to spray-drying, an aqueous solution composed of sodium chloride, a salt modulator and a matrix polymer can include the matrix polymer in the range of 2 weight percent to 15 weight percent of the aqueous solution, more preferably, 5 weight percent to 10 weight percent of the aqueous solution, or a range delimited by these weight percentages.

The low-sodium, salt composition of this invention is prepared by spray drying an aqueous solution composed of sodium chloride, a salt modulator and a matrix polymer to produce the low sodium salt composition composed of a plurality of microspheres having an average particle size of less than 30 microns. Ideally, the average size of the microspheres is controlled by adjusting parameters during the drying process, i.e., a spray drying process, including for example the ratio of salt-to-matrix polymer in the solution, and spray drier parameters, including one or more of the inlet temperature, feed rate, air flow, and spray pressure. For example, in one embodiment, the solution is composed of from about 15 weight percent to about 35 weight percent of sodium chloride and from about 2 weight percent to about 15 weight percent matrix polymer. In one embodiment, the spray drying process includes the use of an inlet temperature of about 180° C. and about 200° C., an outlet temperature of about 80° C. and about 100° C., an air flow between about 180 cubic feet per minute (cfm) to 220 cfm, a feed rate between about 130 g/min and about 160 g/min, and a spray pressure of between about 3 bar and about 5 bar. A non-limiting spray drying process is provided in the examples that follow.

Advantageously, it has been found that the sodium and chlorine of the microspheres of this invention are richly distributed on the particle surface, indicating high exposure or migration of the sodium chloride to the particle surface. Therefore, the present spray dried, low-sodium, salt composition can be used in a variety of applications where a reduction in sodium is required without diminishing salty taste perception. In this respect, the present invention also provides a food containing the spray dried, low-sodium, salt composition. The present composition is particularly suited for any dry or low moisture product. In particular, this invention provides for the topical application of the spray dried, low-sodium, salt composition onto foods such as vegetables, chips (potato, corn, etc.), coatings applied to fried meats (e.g., fried chicken), dried meats (e.g., beef jerky, etc.), nuts (e.g., peanuts, almonds, etc.), crackers, and other food applications.

The spray dried, low-sodium, salt composition may be applied to a food as is (i.e., a spray dried, low-sodium, salt composition consisting of a plurality of microspheres) or may further include an additional component such as a bulking agent, carbohydrate or derivative thereof, hydrocolloid, protein, protein derivative, yeast extract, flavor enhancer, lipid, mineral, salt, or combination thereof.

The following non-limiting examples are provided to further illustrate the present invention.

### Example 1: Preparation of Co-Spray Dried Salt/Modulator

Spray Dried Salt Modulator: In a stainless container equipped with a mechanical stirrer, 2.1 kg of liquid salt modulator intermediate was first introduced. The salt modulator was composed of about 80% water and 20% of a mixture of certain amino acids (e.g., arginine), food acids (e.g., succinic acid, succinic acid, and acetic acid), and carbonate salts (e.g., potassium & magnesium). Subsequently, 0.9 kg acacia gum (SPRDR) was added under agitation. After the gum was fully dissolved, the solution was spray dried with an Anydro MS400 spray dryer, having a target inlet temperature of 190° C., outlet temperature of 90° C., airflow of about 200 cfm, and feed rate of about 145 g/min at 4 bar spray pressure.

Co-Spray Dried Salt with Salt Modulator: Similar to the process for spray drying the salt modulator (above), a spray dried salt with salt modulator composition was prepared (Table 1). Rock salt (NaCl), salt modulator, and water were thoroughly mixed. Subsequently, acacia gum was added and the mixture was stirred until all components were fully dissolved. The solution was then spray dried with an Anydro MS400 spray dryer using the same process conditions described above.

TABLE 1

| | | % of | % of dry |
|---|---|---|---|
| Ingredient | Weight (kg) | solution | weight |
| NaCl Salt | 0.75 | 25% | 56.8 |
| Salt modulator | 0.33 | 11% | 25.0 |
| Acacia gum | 0.24 | 8% | 18.2 |
| Water | 1.68 | 56% | — |
| Total | 3.0 (1.32 dry wt) | 100% | 100% |

### Example 2: Salted Potato Chips

Bulked Up Salt Powder. Because the amount of salt applied to each potato chip is fairly small, a bulked-up powder was prepared to improve dosing uniformity. A maltodextrin was used as the bulking agent. It was calculated at the level that the final chip contained 95% pure potato chip and 5% bulked up powder. The salt was a “fine salt flour” with an average particle size of about 100 microns.

Sample Preparation. In the control sample (100% salt provided as fine salt flour), the salt amount equaled the amount of salt normally found on Lays Classic potato chips, i.e., 432 mg of salt per serving of chips (28 g). Test samples included 52.65% salt (227.6 mg) with 170 mg co-spray dry salt modulator (composed of 42 mg of modulator, 96.65 mg salt, and 31 mg carrier). As such, the total salt in the test samples was 75% (324 mg).

Salted Potato Chips. Commercial Utz “no salt added” potato chips were pre-screened to eliminate too small and too large pieces. Subsequently, 95 g of the screened chips were heated for 70 seconds in a stainless bowl in an oven set at 350° F. After heating, the chips were transferred to a poly bag. The bulked up fine salt powder was sprinkled onto the chips with a spice applicator while gently rotating the chips by shaking the bag.

### Example 3: Sensory Tests

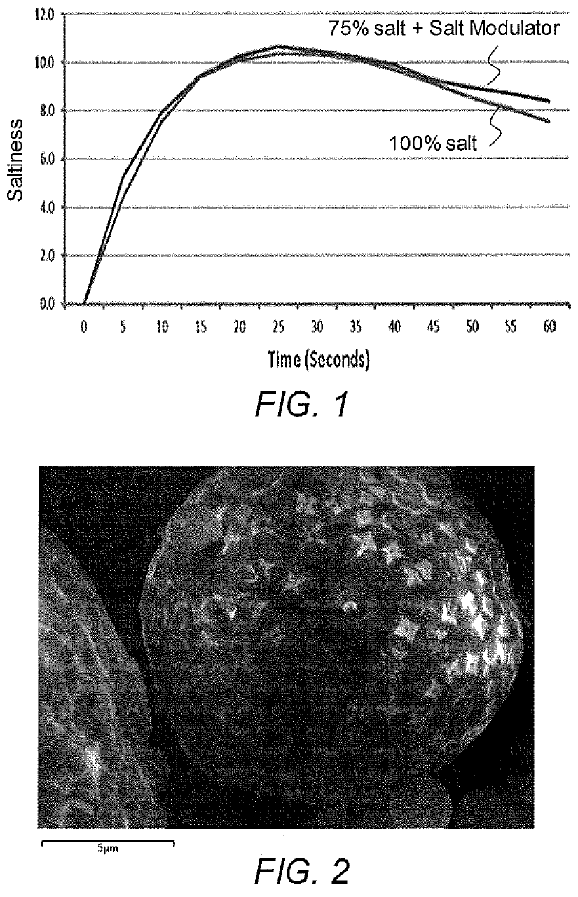

A trained sensory panel with 11 participants tested the chips, and recorded the relative saltiness continuously through an electronic device. The graph shown in FIG. 1 shows the results of this analysis. The overall salty perception of the chips where salt was used in combination with a co-spray dried salt modulator matched regular full salt. Accordingly, this amounted to a 25% reduction in salt used to attain the same level of salt perception as 100% salt.

### Example 4: Scanning Electron Microscope Imaging of Particle Sizes and Salt Mapping

Scanning electron microscope (SEM) images of fine salt (“fine salt flour”), spray-dried salt modulator, and co-spray dried salt with salt modulator were compared and several observations were made. In particular, co-spray dried salt with salt modulator was smaller (mean=26.5 μm, mode=22 μm, D90=42.7 μm, D50=21 μm, and D10=9 μm) than spray-dried salt modulator (mean=47.6 μm, mode=35 μm, D90=80.9 μm, D50=32 μm, and D10=9 μm), and had more uniform microspheres than regular “fine salt flour.” In addition, based upon an energy dispersive X-Ray spectroscopy (EDX) chemical analysis in combination with SEM (FIG. 2), sodium and chlorine were richly distributed on the particle surface of the co-spray dried salt with salt modulator sample, indicating high exposure or migration of salt (NaCl) on the particle surface.

What is claimed is:

1. A spray dried, low-sodium, salt composition comprising a plurality of microspheres, said microspheres comprising:
(a) 35 to 65 weight percent sodium chloride;
(b) 5 to 40 weight percent salt modulator comprising at least one amino acid, at least one food acid, and at least one carbonate salt; and
(c) 5 to 25 weight percent matrix polymer,
wherein said microspheres have an average particle size of less than 30 microns and have the sodium chloride distributed on the surface thereof.

2. The spray dried, low-sodium, salt composition of claim 1, wherein the sodium chloride is 50 to 60 weight percent of the microspheres.

3. The spray dried, low-sodium, salt composition of claim 1, wherein the salt modulator comprises arginine, succinic acid, fumaric acid, acetic acid, potassium carbonate and magnesium carbonate.

4. The spray dried, low-sodium, salt composition of claim 1, wherein the salt modulator is 10 to 30 weight percent of the microspheres.

5. The spray dried, low-sodium, salt composition of claim 1, wherein the matrix polymer comprises one or more of agar, alginate, carrageenan, furcellaran, fucoidin, laminarin, guar gum, tara gum, tamarind seed gum, gum Arabic, alternan, gum tragacanth, gum ghatti, karaya gum, locust bean gum, galactomannan, pusstulan, laminarin, scleroglucan, inulin, konjac seed flour or konjac mannan, pectin, gelatin, psyllium, okra gums, tamarind, dextran, polydextran, gellan gum, rhamsan gum, whelan gum, xanthan gum, zooglan, methylan, chitosan, scleroglucan, dextrin, cyclodextrin, maltodextrin, methyl cellulose, carboxymethylcellulose, hydroxypropylcellulose, hydroxyethyl cellulose, hydroxypropyl methylcellulose, propylene glycol alginate, hydroxyalkylated guar, starch, carboxymethylated guar or modified starches.

6. The spray dried, low-sodium, salt composition of claim 1, wherein the matrix polymer is 15 to 20 weight percent of the microspheres.

7. A method of producing a spray dried, low-sodium, salt composition comprising spray drying an aqueous solution comprising sodium chloride, a salt modulator and a matrix polymer to produce a spray dried, low-sodium, salt composition comprising a plurality of microspheres having an average particle size of less than 30 microns and having the sodium chloride distributed on the surface thereof.

8. The method of claim 7, wherein the spray drying process comprises an inlet temperature of between about 180° C. and about 200° C., an outlet temperature of about 80° C. and about 100° C., an air flow between about 180 cubic feet per minute (cfm) to 220 cfm, a feed rate between about 130 g/min and about 160 g/min, and a spray pressure of between about 3 bar and about 5 bar.

9. The method of claim 7, wherein the sodium chloride is 15 to 35 weight percent of the aqueous solution; the salt modulator is 5 to 20 weight percent of the aqueous solution; and the matrix polymer is 2 to 15 weight percent of the aqueous solution.

10. The method of claim 7, wherein the salt modulator comprises arginine, succinic acid, fumaric acid, acetic acid, potassium carbonate and magnesium carbonate.

11. The method of claim 7, wherein the matrix polymer comprises one or more of agar, alginate, carrageenan, furcellaran, fucoidin, laminarin, guar gum, tara gum, tamarind seed gum, gum Arabic, alternan, gum tragacanth, gum ghatti, karaya gum, locust bean gum, galactomannan, pusstulan, laminarin, scleroglucan, inulin, konjac seed flour or konjac mannan, pectin, gelatin, psyllium, okra gums, tamarind, dextran, polydextran, gellan gum, rhamsan gum, whelan gum, xanthan gum, zooglan, methylan, chitosan, scleroglucan, dextrin, cyclodextrin, maltodextrin, methyl cellulose, carboxymethylcellulose, hydroxypropylcellulose, hydroxyethyl cellulose, hydroxypropyl methylcellulose, propylene glycol alginate, hydroxyalkylated guar, starch, carboxymethylated guar or modified starches.

12. A spray dried, low-sodium, salt composition produced by the method of claim 7.

13. The spray dried, low-sodium, salt composition of claim 12, wherein the plurality of microspheres comprise:
(a) 35 to 65 weight percent sodium chloride;
(b) 5 to 40 weight percent salt modulator comprising at least one amino acid, at least one food acid, and at least one carbonate salt; and
(c) 5 to 25 weight percent matrix polymer.

14. The spray dried, low-sodium, salt composition of claim 12, wherein the sodium chloride is 50 to 60 weight percent of the microspheres.

15. The spray dried, low-sodium, salt composition of claim 12, wherein the salt modulator comprises arginine, succinic acid, fumaric acid, acetic acid, potassium carbonate and magnesium carbonate.

16. The spray dried, low-sodium, salt composition of claim 12, wherein the salt modulator is 10 to 30 weight percent of the microspheres.

17. The spray dried, low-sodium, salt composition of claim 12, wherein the matrix polymer comprises one or more of agar, alginate, carrageenan, furcellaran, fucoidin, laminarin, guar gum, tara gum, tamarind seed gum, gum Arabic, alternan, gum tragacanth, gum ghatti, karaya gum, locust bean gum, galactomannan, pusstulan, laminarin, scleroglucan, inulin, konjac seed flour or konjac mannan, pectin, gelatin, psyllium, okra gums, tamarind, dextran, polydextran, gellan gum, rhamsan gum, whelan gum, xanthan gum, zooglan, methylan, chitosan, scleroglucan, dextrin, cyclodextrin, maltodextrin, methyl cellulose, carboxymethylcellulose, hydroxypropylcellulose, hydroxyethyl cellulose, hydroxypropyl methylcellulose, propylene glycol alginate, hydroxyalkylated guar, starch, carboxymethylated guar or modified starches.

18. The spray dried, low-sodium, salt composition of claim 12, wherein the matrix polymer is 15 to 20 weight percent of the microspheres.

19. A food containing the spray dried, low-sodium, salt composition of claim 1.

20. A food containing the spray dried, low-sodium, salt composition of claim 12.
